(19) United States
(12) Patent Application Publication
(10) Pub. No.: US 2006/0268687 A1
(43) Pub. Date: Nov. 30, 2006

(54) Backup of voice gateway

(76) Inventors: Ilya Umansky, San Jose, CA (US); Radhika Padmanabhan, Saratoga, CA (US); Binh Don Ha, Fremont, CA (US)

Correspondence Address: MARGER JOHNSON & MCCOLLOM, P.C., 210 SW MORRISON STREET, SUITE 400, PORTLAND, OR, 97204, US

(21) Appl. No.: 11/131,511

(22) Filed: May 17, 2005

(51) Int. Cl. H04L 12/26

(52) U.S. Cl. 370/219

(57) ABSTRACT

In a Voice Over IP telephone system, a method and system for switching to a backup gateway. Only the media path is maintained during the switchover. The call setup information and the history of the call (that is, the control path information) are not maintained, thereby greatly simplifying the switchover. Since the call setup information is not maintained, the calls that are switched to the backup gateway cannot be terminated in a normal manner. Instead, the calls are terminated by detecting inactivity in the media path.

### FIELD OF THE INVENTION

This invention relates to telephone communication systems and more particularly to the transmission of telephone calls over a packet network.

### BACKGROUND

Reliability is a very important aspect of telephone systems. In voice over IP (VoIP) systems telephone calls go through network gateways. These gateways are, in general, very reliable pieces of equipment; however, they do sometime fail. Furthermore, in some cases a gateway must be intentionally taken out of service for various operational reasons.

In many systems, gateways have a backup gateway available to handle calls if a primary gateway fails or if it is taken out of service? If a telephone call is in progress over a gateway when the gateway fails or is taken out of service, it is desirable to have a mechanism that can switch the call to a backup gateway without disrupting the call.

Various techniques are known for switching calls to a backup gateway when a primary gateway fails or is otherwise taken out of service. One such known technique is called a “statefull switchover” (SSO). A system utilizing SSO must have a backup gateway that is “hot” (i.e. operating and ready to take over for the primary processor). The switchover must take place while maintaining connectivity.

With SSO, primary and the standby gateway must either both maintain the layer 2 data-link connectivity information or such data must be transferred from the primary process to the standby processor when the switchover occurs. Telephone calls can be transmitted to a network gateway using a wide variety of time division multiplex (TDM) protocols. Each such protocol has its own stack organization, and an SSO must in general be able to handle each of the protocols. The information and state information that must be transferred (or maintained) by the backup gateway using SSO includes both the call setup information and the information concerning how the call is being transmitted.

### SUMMARY

The embodiments described below provide a method and system for switching from a primary gateway to a backup gateway. Only the media path information is maintained on the backup gateway and used during the switchover. The call setup information and the history of the call (that is, the control path information) are not maintained, thereby greatly simplifying the switchover. Since the call setup information is not maintained, the calls that are switched to the backup gateway cannot be terminated in a normal manner. Instead, the calls are terminated by detecting inactivity in the media path.

### BRIEF DESCRIPTION OF THE DRAWINGS

FIG. 1 is an overall block diagram of the first embodiment.

FIG. 2 is a block diagram showing how an orphaned call is handled.

FIG. 3 is a block flow diagram of the first embodiment.

### DETAILED DESCRIPTION OF EMBODIMENTS

Preferred embodiment of the invention are described and discussed below with reference to the drawings listed above. However, it should be understood that various other embodiments are possible. That is, this invention may be embodied in many different forms and the invention should not be construed as being limited to the embodiments set forth herein.

The drawings illustrate various aspects of various preferred embodiments of the invention and the drawings also illustrate various aspects concerning the operation of various embodiments. In the drawings, the size of the boxes is not intended to represent the size of the various physical components. The same reference numerals are used to denote the same elements throughout the drawings.

Only the parts of the various units that are relevant to an explanation of the various embodiments are shown and described herein. It should be understood that the units shown in the drawings and described herein have other conventional parts in addition to those shown and described. Many conventional parts of the embodiments, and many conventional operations performed by the embodiments, are not shown or described herein in that such parts and operations are known to those skilled in the art. However, the description given below conveys, in full, clear, and concise terms, to one skilled in the art, how to make and use the various embodiments.

In the following description and in the appended claims the terms “gateway failure” or “gateway fails” means that the gateway can no longer process calls. Thus, a gateway fails when it stops working due to a mechanical or programming problem or when a gateway is taken out of service for some other reason. Stated differently “failure” of a gateway refers to a gateway being unable to process calls for any reason, including voluntary actions by an operator.

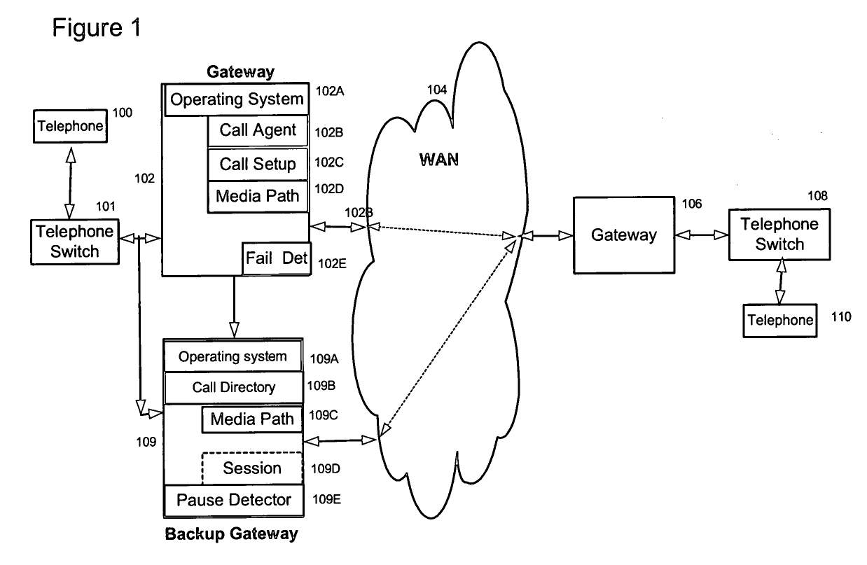

FIG. 1 illustrates a VoIP system that includes a first embodiment of the present invention. As illustrated in FIG. 1, the system includes two conventional telephone switches 101 and 108. Telephone switch 101 is connected to a network gateway 102 that is in turn connected to the packet network 104. Telephone switch 108 is connected to a network gateway 106 that is in turn is connected to the packet network 104. Gateways 102 and 106 are VoIP network gateways. Wide area network 104 can for example be the Internet.

The gateways 102 and 106 are connected to and transmit packets through network 104 and they receive packets from network 104 in a conventional manner. The connection between the telephone switch 101 and gateway 102, and the connection between switch 108 and gateway 106 can, for example, be a conventional T1 connection.

As is conventional, a relatively large number of telephones are connected to each of the switches 101 and 108. However, for convenience of illustration only two exemplary phones 100 and 110 are shown in FIG. 1. It is noted that in other embodiments VoIP telephones can be connected directly to gateways 102 and 108. Telephone calls from telephone 100 to telephone 110 are transmitted through network 104 via packets as is conventional.

The system shown in FIG. 1 includes a backup gateway 109. If gateway 102 fails, telephone call traffic that is being handled by gateway 102 switches over to backup gateway 109 using the technique and mechanism described below. Gateway 109 is connected to network 104 in a conventional manner.

Gateway 102 includes a conventional gateway operating system 102A and gateway 109 includes a conventional gateway operating system 109A. Gateway 102 also includes a conventional failure detection mechanism 102E that provides a signal if gateway 102 fails. For convenience of reference, gateway 102 will be referred to as the primary gateway.

The T1 connection from switch 101 connects to ports on both primary gateway 102 and to backup gateway 109. It is also noted that, the backup system and technique described below does not depend upon the particular signaling protocol used to transmit calls to the gateway 102.

The following description relates to how one call is switched from the primary gateway 102 to the backup gateway 109. As is conventional, gateway 102 can simultaneously handle a large number of calls. The description that follows relates to one particular call. It will be understood by those skilled in the art, that other calls on the gateway are handled in a similar manner to that described.

The following discussion relates to an illustrative example where telephone 100 places a call to telephone 110. When a call is placed by telephone 100, a conventional call agent 102B, which is part of gateway 102, sets up the call and established a media path for the call in a conventional manner. The setup information and medial path relative to an exemplary call are shown in the FIG. 1 and designated call setup 102C and medial path 102D. The call set up information 102C includes information about the origin and destination of the call and information concerning how the call should be handled by the gateway. The call setup information 102C is established in a conventional manner and it includes all the information conventionally generated by a call agent that sets up a call.

When a call is setup on gateway 102, a subset of the setup information is transferred to and stored in backup gateway 109. The only data transferred to backup gateway 109 is the data that defines the media path used by the call. This is a subset of the information generated by the call agent 102B during the call setup. The information concerning the media path, which is transferred to and stored on gateway 109, is essentially not dependent upon the signaling protocol used to transmit the call to the gateway 102. The information that defines the media path is indicated by block 109C in FIG. 1. As described below, since all the call setup information is not transferred to gateway 109, if a call is transferred to gateway 109, a special technique must be used to terminate the call.

For each call handled by gateway 102, the six items of information listed below, which are generated during a conventional call set up procedure by call agent 102B, and which define the media path used by the call, are stored in a call directory in the backup gateway 109.

The six items stored in the call directory on backup gateway 109 are:
1) The call's GUID (the Global call ID)
2) The Codex used including any keys or encryption algorithm.
3) The associated DSO:
4) Destination IP address
5) RTP port and RTP SSRC
6) Local IP address.

The call GUID: The GUID is a unique number that is assigned to each VoIP call. In conventional VoIP systems, when a particular call is set up, the call agent that sets up the call generates a GUID number, which uniquely identifies the particular call. In the system shown in FIG. 1, the GUID is generated in a conventional manner.

The Codec used including any keys or encryption algorithm: When a particular call is set up, the call set up process includes deciding upon a specific codec that will be used to code and de-code packets for the call. In certain situation, keys and/or encryption algorithms are also used. In the system shown in FIG. 1, the codec, keys and encryption algorithms that will be used for a call are established in a conventional manner.

The DSO identification: Telephone switch 101 transmits calls to gateway 102 on a trunk line that includes a number of DSO paths. Each particular call is transmitted to the gateway on one particular DSO. The DSO identifier identifies the particular DSO on which a call was received.

The Destination IP address: IP packets include a header which identifies the destination to which the packet is directed. At call set up time the destination IP address is determined. In the system shown in FIG. 1, this is done in a conventional manner.

The RTP port and RTP SSRC: When a gateway establishes an RPT session, the gateway establishes a port and a unique RPT stream identifier called an RTP SSRC. This identifier identifies a particular RTP stream in the same way that a GUID identifies a particular call. In the system shown in FIG. 1, this is done in a conventional manner.

Local IP Address: This is the IP address of the gateway 102.

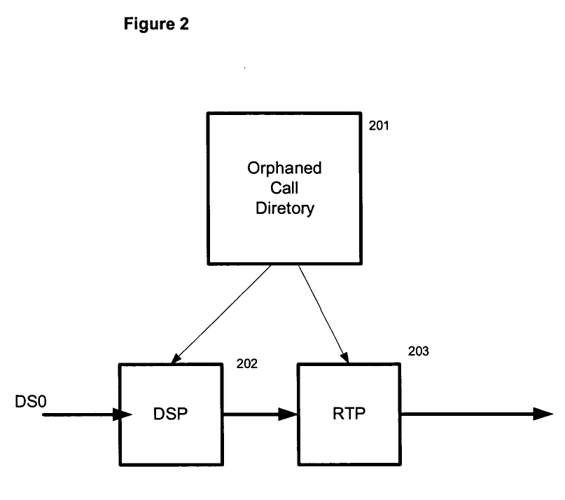

A directory 109B is formed on the backup gateway that includes the above information for each of the calls being handled by gateway 102. This directory is stored on gateway 109 at the time that the call agent in gateway 102 sets up the call. When gateway 102 fails and a call is transferred to gateway 109, it is called an orphaned call. The directory for one particular orphaned call is illustrated in FIG. 2.

When gateway 102 fails and the transition from gateway 102 to 109 occurs, a software entity, called a session, is initiated on the backup gateway 109 for each call transferred. When the failure detection mechanism 102E detects that gateway 102 has failed, gateway 109 is activated and the media path for all calls then in progress is activated on gateway 109. Each call transferred is called an orphaned call. It is noted that the information necessary to activate the media paths on gateway 109 is transferred during call setup and is available in case gateway 102 fails and the calls must be switched to gateway 109.

For each orphaned call, a session is allocated in gateway 109. In the FIG. 1, a dotted box labeled session 109D is shown in backup gateway 109. The box is shown using a dotted line to indicate that this session is not allocated by the gateway operating system 109A until gateway 102 fails and a call is transferred from gateway 102 to gateway 109. While only one session is specifically shown in FIG. 1, it should be understood that a session is established for each transferred call.

Each session established in backup gateway 109 includes:
1) A digital signal processor (DSP) channel, loaded With the codec and cross-connected to the DSO that is specified for the particular orphaned call directory.
2) A Real Time Protocol (RTP) session. The RTP session receives packets from the DSP, appends the RTP header and sends the packet to the destination IP address specified in orphaned calls directory entry. With respect to packets arriving from the network, (for the particular call) they are directed to appropriate DSP that applies the appropriate codec to the packets.

The components of a session on backup gateway 109 are illustrated in FIG. 2. The session includes a DSP channel illustrated by block 202 and an RTP session as indicated by the block 203. The DSP channel 202 and the RTP session 203 are setup bases upon the information in the orphaned call directory 201.

Thus, when gateway 102 fails, backup gateway 109 begins operating and gateway 109 continues transmitting packets through the packet network to their destination. Likewise backup gateway 109 process packets received from the network and direct them to their appropriate destination.

The active DSOs on the backup gateway 109, after switchover to the backup gateway 109, are associated with a signaling-less Common Channel Signaling (CCS) trunk group. CCS treatment of the call after switchover avoids the need to have knowledge concerning the details of the signaling protocol. After the call setup is complete a call can be viewed as being signaling-less.

In the embodiment shown in FIG. 1, the, T1 trunk connection from the telephone switch 101 to the gateway 102 includes a physical group of DSOs as is conventional. This physical group of DSOs can be partitioned into multiple logical groups with different signaling protocols. As an example, we will consider an embodiment where the input to the gateways 102 and 109 utilizes three signaling protocols:
a) E&M protocol (recEive and transMit) This is a known trunking arrangement conventionally used for two-way switch-to-switch or switch-to-network connections.
b) E1R2 protocol: This is an international signaling standard that is common to channelized E1 networks. E1 is a wide-area digital transmission scheme used predominantly in Europe that carries data at a rate of 2.048 Mbps.
c) CCS (common channel signaling): CCS is a signaling system used in telephone networks that separates signaling information from user data. A specified channel is exclusively designated to carry signaling information for all other channels in the system

As a specific example consider an embodiment where the input to gateways 102 and 109 is a connection that includes three DSOs of E&M, ten DSOs of E1R2, and twenty-one DSOs of CCS. In such an embodiment when switchover occurs to backup gateway 109, all the DSOs on the backup gateway 109 are assigned to a single signaling-less logical group until the call ends. After calls are terminated, the DSOs are returned to the original signaling group where they were assigned. This type of group assignment does not involve any physical channel movement and it is handled in a conventional manner by the operating system. Each switched over call will have a session as described above which provides the media path for the particular call.

When an orphaned call ends, the gateway 109 does not have the call signaling information available and it cannot terminate the call in a conventional manner. Instead, a pause detector 109E in gateway 109 monitors each call to detect if a period of inactivity occurs. When a period of inactivity, of certain duration, is detected, the media path is closed. The length of the period is a matter of engineering choice. For example it can be set to a value of 2 seconds.

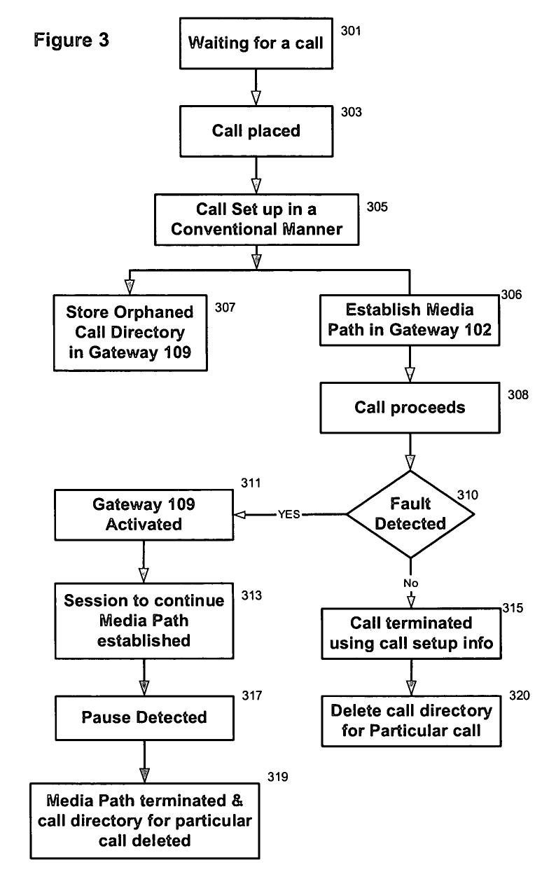

FIG. 3 is a flow diagram illustrating the operation of the system. The process begins with gateway 102 waiting to receive a call. When a call is placed by a telephone connected to switch 101, switch 101 sends the call signaling information to gateway 102 in a conventional manner. Block 303 indicates when a call is placed and the call signaling arrives at gateway 102.

The call is setup by gateway 102 in a conventional manner by a call agent as indicated by block 303. The call setup process, establishes a media path in gateway 102 as indicated by block 306. At the same time the orphaned call directory is established in gateway 109 as indicated by block 307. The call then proceeds in a conventional manner as indicated by block 308.

If no fault is detected (as indicated by block 310), the call is eventually terminated by the call agent in gateway 102 in a conventional manner using the call setup information as indicated by block 315. When a particular call on gateway 102 is terminated, the orphaned call directory on gateway 109 for that particular call is deleted as indicated by block 320.

If a fault is detected (as indicated by block 310), gateway 109 is activated as indicated by block 311. A session is established in gateway 109 (see FIG. 2). The session in gateway 109 establishes a medial path utilizing the information in the orphaned call's directory as indicated by block 313.

The call then proceeds until pause detector 109E detects a pause in the transmission of information over the media path that was established (block 317). When a pause is detected, the media path is terminated as indicated by block 319. When the media path for a particular call is terminated, the orphaned call directory for that particular call is deleted.

It should be noted that the block diagram in FIG. 3 relates to only one particular telephone call. At any time, a gateway may be handling multiple calls, and the process would be repeated for each of the call.

It is also noted that some of the blocks shown in FIG. 1, such as setup 102C, media path 102D, failure detector 102E, media path 109C, session 109D and pause detector 109E are implemented using conventional software mechanisms.

As is conventional the gateways report calls using conventional call detail records (CDRs). For orphaned calls, the quid of the orphan call can be used to establish the CRD. In order to avoid over billing, a stop record can be sent as soon as the call is reestablished on the backup gateway. In such a situation, the orphaned call on gateway 109 would be free of charge. Alternatively, the stop record can be sent based upon the detection of a pause in the call. In this way the time used by the orphaned call can be charged as appropriate.

It is noted that if the trunk, from telephone switch 101, uses out-of-band signaling (such as ISDN) the d-channel must be served by the backup gateway. Appropriated precautions need be taken to insure that an abnormal disconnect of a DSO running active calls does not occur when the stack on the backup gateway is coming up after a switchover. Such an abnormal disconnect can happen is the ISDN layer 2 timer expires.

The scheme described above can be extended with the use of additional signaling information if such extension is desired. Furthermore, additional layers of redundancy can be provided by the use of checkpointing. For example, the ISDN call reference number and/or the Session Initiation Protocol (SIP) or the H.313 Version 4 protocol can be checkpointed as described below.

ISDN call reference number: The ISDN call reference number is a per call based number. It can be used to map to the GUID of a call. Using the ISDN call reference number, one can handle events such as disconnect/release after switchovers to the backup sever.

Call reference number is not required in the case of ISDN Primary Rate Interface (PRI) because in this case signals are not back hauled from layer 2 to the Call Agent. In this case, the call agent maintains the correct state machine for layer 3. In other cases the orphaned call process receives the events from layer 2 of the protocol, and it handles the disconnect by comparing the checkpointed call reference numbers with the call reference numbers associated with the event. This allows for call clean up.

Session Initiation Protocol (SIP) or the H.313 Version 4 protocol: Other embodiments checkpoint the User Datagram Protocol (UDP) local port of the signaling connection. The SIP called One can also be checkpointed. With H.323 GUID is already checkpointed. The ‘BYE’ command from SIP or H.323 “Release Complete Message” can be handled by matching the call ID in SIP (or the GUID in H.323) to the active call session maintained for an orphaned call. In summary, using checkpointing a system can handle some or all of the SIP events arriving or sent on a SIP signaling port.

It is noted that in the embodiment shown herein, the telephones are connected d to the gateways through telephone switches. In other embodiments, the telephones are connected directly to the gateways. In such embodiments, the backup operation proceeds similar to that described above.

It is also noted that the above description relates to how calls are handled that are in progress when the switchover to the backup gateway occurs. Call that are placed after the switchover occurs, are handled by the backup gateway 109 in a conventional manner. Thus, backup gateway 109 includes a conventional call agent (not shown in the Figure) to handle calls that are placed after the switchover occurs.

While the invention has been shown and described with respect to preferred embodiments thereof, it will be understood by those skilled in the art that various other embodiments are possible.

I claim:

1. A backup system for a primary gateway that is adapted to connect and: transmit telephone calls over a packet network, said primary gateway including a call agent that establishes a media path through said network for each telephone call, and a detector to detect when said primary gateway fails, said backup system including:
a backup gateway including,
an orphan call directory for each telephone call being handled by said primary gateway when said primary gateway fails, each orphan directory containing enough information to establish the media path of the associated call,
a session on said backup gateway for each orphaned call, said session being initiated when said primary gateway fails, said session utilizing the information in said orphan directory to establish the media path for each call and,
a detector for detecting a pause, having a length longer than a pre-established value, in each media path established, a media path being terminated when a pause having a length longer than said pre-established duration occurs in said media path.

2. The backup system recited in claim 1 wherein said orphan call directory includes for each call, said call's GUID, assigned codec, associated DSO, destination IP address, RTP port and RTP SSRC, and Local IP address.

3. The backup system recited in claim 1 wherein a telephone switch is connected to said primary gateway and to said backup gateway.

4. The backup system recited in claim 1 wherein a telephone switch provides telephone calls to both said primary gateway and to said backup gateway and said backup gateway is only active when said primary gateway fails.

5. The backup system recited in claim 1 wherein said primary gateway and said backup gateway are connected to and transmit packets over a wide area network.

6. The backup system recited in claim 1 wherein said network is the Internet.

7. The backup system recited in claim 1 wherein said backup gateway includes a call agent that sets up calls placed after said primary gateway fails, said calls being setup in and handled by said backup gateway.

8. The backup system recited in claim 1 wherein said primary gateway and said backup gateway are VoIP gateways.

9. The backup system recited in claim 1 wherein calls are transferred from said primary gateway to said backup gateway when said primary gateway fails and said calls are handled on said backup gateway by establishing on said backup gateway only the media path for each call.

10. A method for backing up a primary gateway that is adapted to connect and transmit telephone calls over a packet network, said method utilizing a backup gateway, said primary gateway including a call agent that establishes a media path through said network for each telephone call handled by said primary gateway, and a detector to detect when said primary gateway fails, said method including:
at call setup time, establishing an orphan call directory on said backup gateway for each telephone call that is setup by said call agent in said primary gateway, each orphan directory containing enough information to establish the media path of the associated call,
when said primary gateway fails, establishing a session on said backup gateway for each orphaned call, said session utilizing the information in said orphan directory to establish the media path for each call,
detecting pauses having at least a pre-established length on each of said media paths and,
terminating a media path when a pause of at least said pre-established length is detected.

11. The method recited in claim 10 wherein said orphan call directory includes for each call, said call's GUID, assigned codec, associated DSO, destination IP address, RTP port and RTP SSRC, and Local IP address.

12. The method recited in claim 10 wherein a telephone switch is connected to said primary gateway and to said backup gateway.

13. The method recited in claim 10 wherein a telephone switch provides telephone calls to both said primary gateway and to said backup gateway and said backup gateway only handles calls when said primary gateway fails.

14. The method recited in claim 10 wherein said primary gateway and said backup gateway are connected to and transmit packets over a wide area network.

15. The method recited in claim 10 wherein said backup gateway includes a call agent that sets up calls placed after said primary gateway fails, said calls being setup in and handled by said backup gateway.

16. The method recited in claim 10 wherein said primary gateway and said backup gateway are VoIP gateways.

17. A computer readable medium having stored thereon sequences of instructions which when executed practice the method recited in claim 10.

18. A computer readable medium having stored thereon sequences of instructions, which when executed practice the method recited in claim 11.

19. A system for backing up a primary gateway that is adapted to connect and transmit telephone calls over a packet network, said system utilizing a backup gateway, said primary gateway including a call agent that establishes a media path through said network for each telephone call handled by said primary gateway, and a detector to detect when said primary gateway fails, said system including:
means, operable at call setup time, for establishing an orphan call directory on said backup gateway for each telephone call that is setup by said call agent in said primary gateway, each orphan directory containing enough information to establish the media path of the associated call,
means operable when said primary gateway fails, for establishing a session on said backup gateway for each orphaned call, said session utilizing the information in said orphan directory to establish the media path for each call,
means for detecting pauses having at least a pre-established length on each of said media paths and,
means for terminating a media path when a pause of at least said pre-established length is detected.

20. The system recited in claim 20 wherein said orphan call directory includes for each call, said call's GUID, assigned codec, associated DSO, destination IP address, RTP port and RTP SSRC, and Local IP.
